(19) United States
(12) Patent Application Publication
(10) Pub. No.: US 2012/0090962 A1
(43) Pub. Date: Apr. 19, 2012

(54) DEVICE FOR DRIVING PHOTOVOLTAIC CELLS OR THEIR SUBSTRATES DURING THE PROCESS FOR MANUFACTURE OF THE PHOTOVOLTAIC CELLS

(75) Inventors: Luis Maria Antonello, Rome (IT); Mariano Zarcone, Nettuno (IT)

(73) Assignee: Microsic s.r.l

(21) Appl. No.: 13/264,490

(22) PCT Filed: Apr. 12, 2010
(86) PCT No.: PCT/IT10/00151

§ 371 Date: Dec. 19, 2011

(30) Foreign Application Priority Data
Apr. 15, 2009 (IT) RM2009A000172

(51) Int. Cl. B65G 13/02

(52) U.S. Cl. 198/780

(57) ABSTRACT

It relates to a driving device comprising at least one pair of tubular elements or coaxial rollers made of ceramic material, titanium, alumina or the like, positioned opposite each another and at a distance from one another such that at least one photovoltaic cell or associated substrate or the like rests on the opposite ends of said pair of coaxial rollers.

### FIELD OF THE INVENTION

The present invention relates to a device for driving photovoltaic cells or their substrates, such as organic, inorganic and hybrid-based materials, during the process for manufacture of the photovoltaic cells

### PRIOR ART

During the process for manufacture of photovoltaic cells the substrates, i.e. the materials from which said cells are derived, are inorganic-based materials such as mono- and polycrystalline silicon-based materials or organic-based materials such as blueberry pigments or hybrid—i.e. organic- and inorganic-based materials. These substrates undergo a series of treatments in special plants so as to produce photovoltaic cells as final products.

In particular, the treatments comprise:
a chemical bath in a solution which etches the surface of the silicon slice, converting it from a smooth to composite form, with micro-pyramid shapes which manage to capture fully the sun's rays and reduce reflection to a minimum;
doping during which the “p-n” junction of the silicon slice is formed by means of thermal diffusion in a high-temperature furnace (approximately 1000° C.). During this operation a layer of phosphorous or other doping material is deposited on the silicon in a given concentration and to a given depth, so as to act as a separator of the light photons, converting them into positive-negative electrical charges; and
a serigraphic process during which a silver paste is deposited on the front side of the cell and an alumina paste is deposited on the rear side thereof in an automated manner by means of serigraphy. As a result it is possible to collect together all the electric charges so that they converge towards the primary negative-positive conductors. In particular, sintering of the metal contacts, which are printed on the photovoltaic cells by means of serigraphy or other known equivalent techniques, influences considerably the quality of the energy conversion of the photovoltaic cells and their efficiency.

These treatments are performed in special plants where the materials are transported through various treatment chambers characterized by different temperatures.

In conventional plants for the production of photovoltaic cells and in particular in sintering furnaces, such as those with infrared lamps or ohmic resistors, transportation of the photovoltaic cells through the various treatment stations along the plant is performed by a driving device consisting of a metal belt able to withstand normal sintering temperatures which may be as high as 1000° C., and the use of said metal belt gives rise to several drawbacks.

A first drawback consists in the considerable expenditure of energy due to the fact that the metal belt is subject to continuous heating and cooling cycles. The cooling cycle is necessary in order to handle the photovoltaic cells after firing, since they must in fact be cooled, together with the metal belt, to a maximum temperature of 40° C.

Another drawback consists in the fact that said metal belt, because of its nature, tends to release particles which penetrate into the photovoltaic cells at a high temperature and contaminate them, reducing their efficiency.

A further drawback is due to the metallic mass of the belt which, having a considerable thermal inertia, does not allow steep temperature profiles. Moreover, the static thermal profile of the furnace is different from the dynamic profile with a consequent difficulty in measurement of the temperature and precise definition thereof. In fact, the metal belt passes through all the chambers and results in mean temperatures which are different from those present in each chamber.

In order to overcome some of these drawbacks, a device for driving photovoltaic cells formed by means of continuous, ceramic, coaxial rollers which extend along their entire length and each of which rotates, remaining fixed in its position, has been used.

Rotation of the rollers causes driving of the cells through the furnace. However, the use of such a solution has a number of drawbacks such as the friction between the roller and the metal paste, which is usually silver-based, in particular when the latter is in the drying phase; this friction results in the formation of a irregular areas and removal of the layer of paste from given zones. Moreover, in the so-called firing zone, where high-temperature sintering of the powders forming the conductive paste occurs and where the organic compounds evaporate, the metal paste tends to corrode and react also with the rollers with the dual drawback of causing wear of these rollers and contamination of the photovoltaic cell with particles of material of said rollers.

There therefore exists a need to overcome the abovementioned drawbacks.

### SUMMARY OF THE INVENTION

There has now been developed, this forming the subject of the present invention, a device for driving photovoltaic cells or their substrates, i.e. the precursor materials, for plants for manufacturing photovoltaic cells, in particular used for sintering furnaces, which overcomes these drawbacks.

The device, according to the present invention, is defined in the claims and illustrated in the accompanying drawings.

The driving device is characterized in that it comprises at least one pair of tubular elements or coaxial rollers made of ceramic material, titanium, alumina or the like positioned opposite each other and at a distance from one another such that at least one photovoltaic cell or associated substrate or the like rests on the opposite ends of said pair of coaxial rollers.

The coaxial rollers of each pair are designed and have dimensions such that both the surfaces of each photovoltaic cell or associated substrate are irradiated by means of the known type, such as infrared lamps, or are treated during the various stages of the process for manufacture of said cells except for the contact surface between the photovoltaic cells and the coaxial rollers.

Further characteristic features and intended functions of the driving device according to the present invention will become clear from the detailed description which follows.

The present invention will now be described in greater detail with reference to preferred embodiments, although it is understood that variations may be made without thereby departing from its scope of protection defined by the accompanying claims and with reference to the figures of the accompanying drawings.

### BRIEF DESCRIPTION OF THE FIGURES

FIG. 1 is a schematic perspective view of a device for driving photovoltaic cells of the known type.

FIG. 2 is a top plan view of the driving device according to FIG. 1.

FIG. 3 is a side view of the driving device according to FIG. 1.

FIG. 4 shows a roller of the driving device according to FIG. 1.

FIG. 5 is a schematic perspective view of the device for driving photovoltaic cells or associated precursor materials according to the invention.

FIG. 6 is a top plan view of the driving device according to FIG. 5.

FIG. 7 is a side view of the driving device according to FIG. 5.

FIG. 8 is a front view of the driving device according to FIG. 5.

FIG. 9 shows in detail one end of a roller on which a photovoltaic cell rests.

### DETAILED DESCRIPTION OF A PREFERRED EMBODIMENT OF THE INVENTION

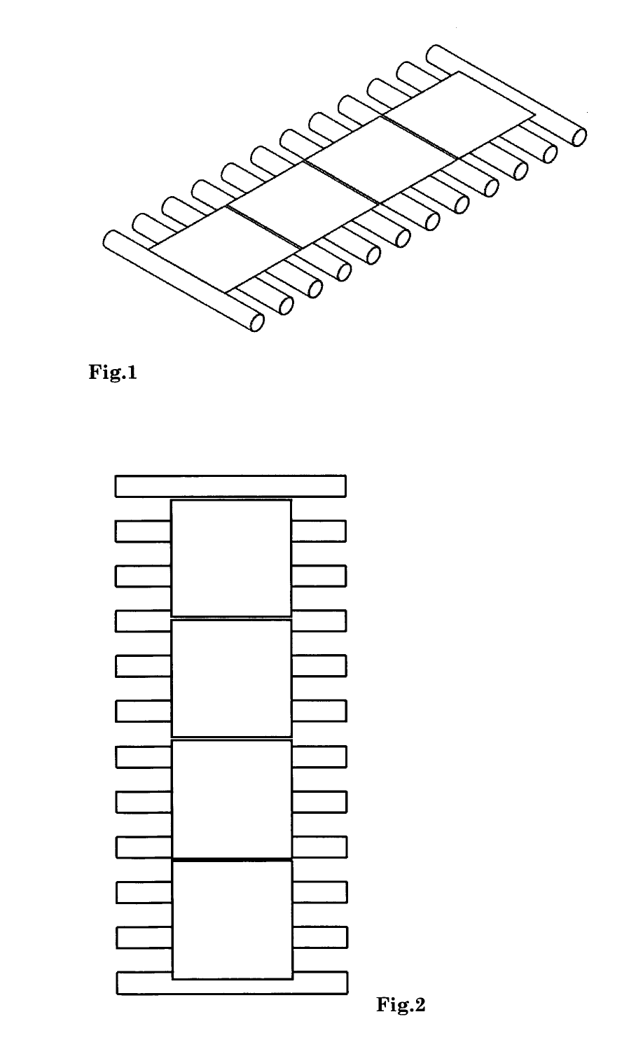

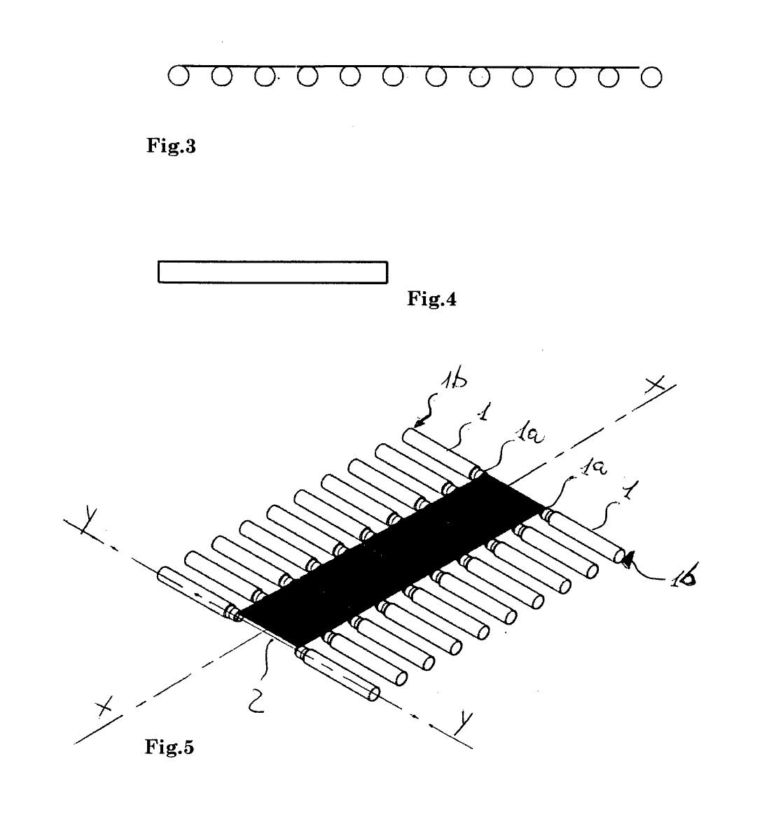

With reference to FIGS. 1 to 4, these show a conventional driving device comprising a plurality of continuous cylindrical rollers which extend over their whole length and which cover part of the surface of the photovoltaic cell or the substrates which must undergo the treatments along the plant for manufacturing the photovoltaic cells.

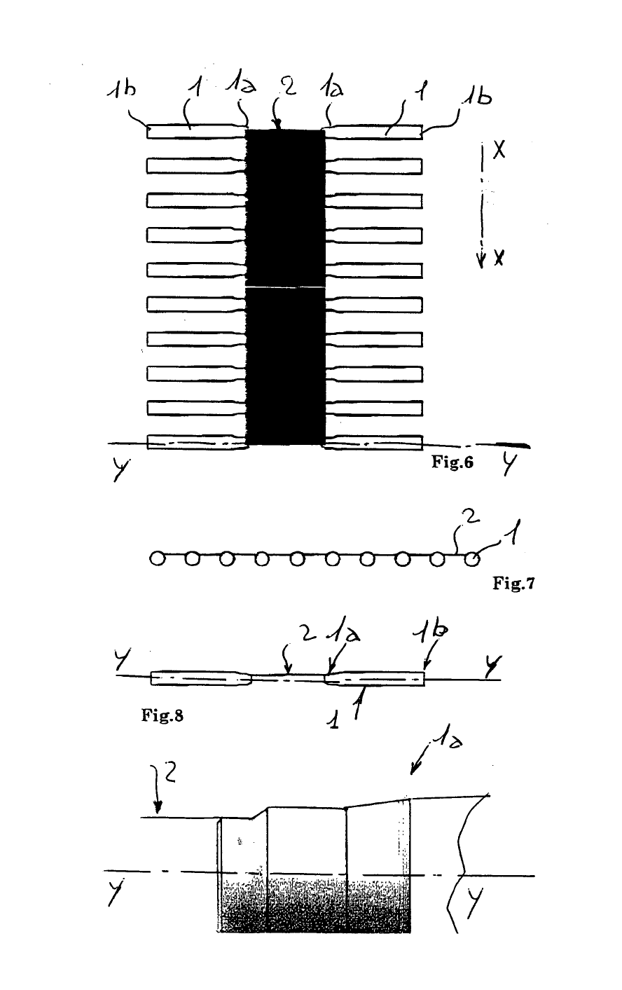

With reference to FIGS. 5 to 9, a preferred embodiment of the device for driving photovoltaic cells or associated precursor materials or substrates in the longitudinal direction of feeding X-X is shown. The present invention comprises at least one pair of tubular elements or coaxial rollers 1, which are preferably made of ceramic material, titanium, alumina or other materials with similar characteristics, which are positioned opposite each other and at a distance from one another in the transverse direction Y-Y so that at least one photovoltaic cell 2 rests or is supported preferably on the ends of said coaxial rollers 1.

Each of the coaxial rollers 1 in the pair is provided with a special internal engaging end 1a on which the photovoltaic cell 2 rests and an external end 1b, opposite to the engaging end 1a, connected to rotational actuating means (not shown).

Said internal engaging ends 1a of the coaxial rollers 1 of each pair face each other such that a photovoltaic cell is able to rest by means of the portions of two opposite lateral edges on a corresponding engaging end 1a of at least one pair of coaxial rollers 1. Preferably the contact zone between each photovoltaic cell 2 and at least one pair of coaxial rollers 1 is minimal, being limited to said portions.

The coaxial rollers 1 and the engaging ends 1a are designed and have dimensions such that each surface of said photovoltaic cell 2 is retained and/or irradiated by means of the known type (not shown), except for the contact surface between said cells 2 and the engaging ends 1a of said coaxial rollers 1. However, the cell support surface is minimal compared to the entire surface which is in fact left free and completely exposed to the infrared rays of the lamps.

In the present embodiment, the driving device comprises a plurality of pairs of coaxial rollers 1 positioned opposite each other so as to allow a plurality of photovoltaic cells 2 to rest and be driven, by means of the rotational movement of the coaxial rollers, through the furnace and therefore be treated or irradiated on each surface.

The internal engaging ends 1a are shaped so as to afford a stable support for each photovoltaic cell 2, in particular its two opposite side edges.

Each internal engaging end 1a has a plurality of adjacent cylindrical and frustoconical portions, as shown in FIG. 9, of suitably varying dimensions, connected in such a way as to create one or more steps so as to afford a stable support for the photovoltaic cells, even if they are different in size.

It is also clear how, by means of the device for driving photovoltaic cells or their substrates according to the present invention, there is a considerable saving in the amount of energy used and the quality of the finished photovoltaic cells is also improved since they are contaminated to a significantly lesser degree and therefore have a greater efficiency, without irregularities and with a uniformly distributed layer consisting preferably of silver-based paste. Moreover, the said coaxial driving rollers are neither contaminated, nor soiled nor subject to wear as a result of the abrasive action of the said paste.

1. A device for driving photovoltaic cells or their substrates in a longitudinal direction X-X, comprising at least one pair of tubular elements or coaxial rollers positioned opposite each another and at a distance from one another in a transverse direction Y-Y suitable for allowing supporting of at least one photovoltaic cell by means of an internal engaging end of each roller for driving said cell.

2. The device according to claim 1, wherein the oppositely arranged internal engaging ends of the two coaxial rollers support respective longitudinal edges of said photovoltaic cell.

3. The device according to claim 1, wherein said rollers have comprises an external end, opposite to the internal engaging end for supporting said cell, connected to rotational actuator.

4. The device according to claim 1, wherein the internal engaging end is provided with a plurality of adjacent cylindrical and frustoconical portions connected in such a way as to create one or more steps so as to afford a stable support for the photovoltaic cells.

5. The device according to claim 1, wherein said coaxial rollers are made of ceramic material, alumina, titanium or materials with similar characteristics.
